(19) United States
(12) Patent Application Publication
(10) Pub. No.: US 2020/0410182 A1
(43) Pub. Date: Dec. 31, 2020

(54) Hybrid Illumination Attachment for Symbology Readers

(71) Applicant: ZEBRA TECHNOLOGIES CORPORATION, Lincolnshire, IL (US)

(72) Inventors: Miguel Orlando Rodriguez Ortiz, Coram, NY (US); Igor Vinogradov, Oakdale, NY (US); Edward Barkan, Miller Place, NY (US)

(21) Appl. No.: 16/457,534

(22) Filed: Jun. 28, 2019

(51) Int. Cl. G06K 7/14; G02B 3/08; G02B 5/02

(52) U.S. Cl. CPC G06K 7/1413; G02B 5/021; G02B 5/0294; G02B 3/08

(57) ABSTRACT

Attachments for symbology readers to extended operability of the symbology readers to include reading DPM codes on objects therewith are provided. The attachment includes a mount configured to couple the symbology reader to the attachment and a housing that defines a cavity defined by one or more walls. The attachment includes a diffuser positioned within the cavity and configured to diffusingly reflect light that impinges thereon. The attachment also includes a first optical element configured to direct a first amount of a total amount of the illumination light to impinge on the diffuser.

### BACKGROUND OF THE INVENTION

Existing symbology readers include a single imaging assembly configured to read a particular type of code. For example, one symbology reader may include an imaging assembly optimized to read barcodes printed on packaging; another symbology reader may include an imaging assembly optimized to read codes presented on a digital screen; yet another symbology reader may include an imaging assembly optimized to read direct part marking (DPM) codes. However, in some environments, the ability to read multiple types of code is required. Traditionally, one would have to carry around and switch between multiple symbology readers to read the different types of codes. However, the different types of codes may be more easily read under different illumination conditions. Accordingly, there is a need for a hybrid illumination attachment for symbology readers.

### SUMMARY

Embodiments of the present disclosure include an attachment for a symbology reader. The attachment comprises a mount configured to couple the symbology reader to the attachment and a housing that defines a cavity defined by one or more walls. The attachment also includes a diffuser positioned within the cavity. The diffuser is configured to diffusingly reflect light that impinges thereon. The attachment also includes a first optical element configured to direct a first amount of a total amount of illumination light produced by the symbology reader to impinge on the diffuser.

Additional embodiments of the present disclosure include an attachment for a symbology reader. The attachment includes a holder configured to couple the symbology reader to the attachment and a housing that defines a cavity being further defined by one or more walls. The attachment also includes a diffuser positioned within the first portion of the cavity. The diffuser is configured to diffusingly reflect light that impinges thereon. The attachment also includes a lens assembly configured to direct the illumination light that passes from the symbology reader toward the attachment to impinge upon the diffuser.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A illustrates front and rear perspective views of a symbology reader, in accordance with an embodiment of the present invention.

FIG. 1B illustrates a side perspective view of a hybrid illumination attachment, in accordance with an embodiment of the present invention.

FIG. 1C illustrates a side perspective view of a hybrid illumination attachment that includes a stand, in accordance with an embodiment of the present invention.

FIG. 1D is an example environment where the symbology reader of FIG. 1A is coupled to the hybrid illumination attachment of FIG. 1B to read a DPM code, in accordance with an example.

FIG. 1E is an example environment where the symbology reader of FIG. 1A is uncoupled from the hybrid illumination attachment of FIG. 1B to read a barcode code, in accordance with an example.

FIG. 2 is an exploded view of the symbology reader and hybrid illumination attachment of FIG. 1 that illustrates an optical path for light produced by an illumination assembly the symbology reader and passing through a housing of the hybrid illumination attachment in a manner that produces diffuse illumination.

FIG. 3A is an exploded view of a housing of the hybrid illumination attachment of FIGS. 1 and 2 illustrating an optical path for light produced being directed toward a diffuser by an obscurator.

FIG. 3B is an exploded view of a housing of the hybrid illumination attachment of FIGS. 1 and 2 illustrating an optical path for light produced being directed toward a diffuser by a lens.

FIG. 3C is an exploded view of a housing of the hybrid illumination attachment of FIGS. 1 and 2 illustrating an optical path for light produced being directed toward a diffuser by a lens having a lower reflector portion.

FIG. 3D is an exploded view of a housing of the hybrid illumination attachment of FIGS. 1 and 2 illustrating an optical path for light produced being directed toward a diffuser by a Fresnel lens.

FIG. 4A is a perspective view of the attachment of FIGS. 1-2, in accordance with an example embodiment.

FIG. 5 is an side perspective view of a housing of the symbology reader of FIG. 1 illustrating an example diffuser shape that improves the uniformity of diffuse illumination produced by the attachment, in accordance with an example embodiment.

FIG. 6A is a side perspective view of a housing of the attachment of FIG. 5 illustrating an optical path for light produced by an illumination assembly being directed toward a diffuser by an axicon reflector, in accordance with an example embodiment.

FIG. 6B is a side perspective view of a housing of the attachment of FIG. 5 illustrating an optical path for light produced by an illumination assembly being directed toward a diffuser by a pyramidal reflector, in accordance with an example embodiment.

FIG. 6C is a side perspective view of a housing of the attachment of FIG. 5 illustrating an optical path for light produced by an illumination assembly being directed toward a diffuser by a conical reflector, in accordance with an example embodiment.

FIG. 6D is a side perspective view of a housing of the attachment of FIG. 5 illustrating an optical path for light produced by an illumination assembly being directed toward a diffuser by a revolved prism refractor, in accordance with an example embodiment.

FIG. 6E is a side perspective view of a housing of the attachment of FIG. 5 illustrating an optical path for light produced by an illumination assembly being directed toward a diffuser by an axicon refractor, in accordance with an example embodiment.

FIG. 6F is a side perspective view of a housing of the attachment of FIG. 5 illustrating an optical path for light produced by an illumination assembly being directed toward a diffuser by a Fresnel refractor, in accordance with an example embodiment.

FIG. 6G is a side perspective view of a housing of the attachment of FIG. 5 illustrating an optical path for light produced by an illumination assembly being directed toward a diffuser by a microlens array refractor, in accordance with an example embodiment.

FIG. 7 is a side perspective view of a housing of the attachment of FIG. 5 illustrating an optical path for light produced by an illumination assembly being directed toward a diffuser via light pipes, in accordance with an example embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

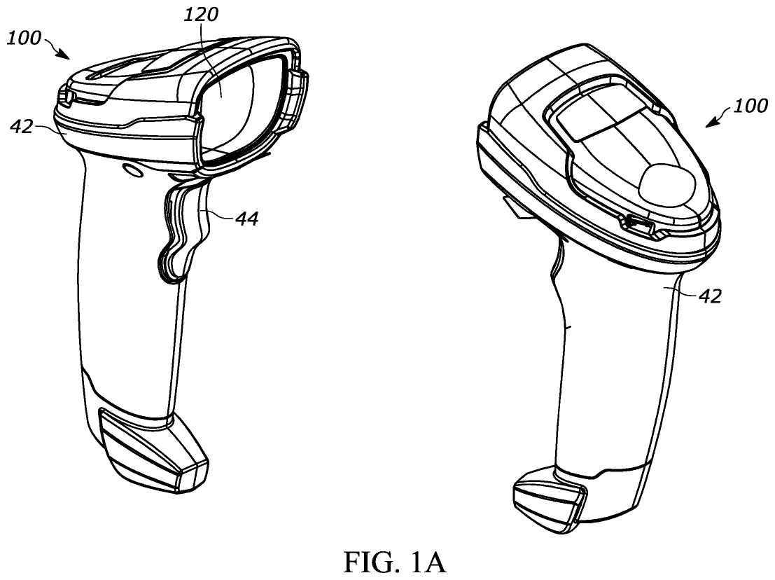

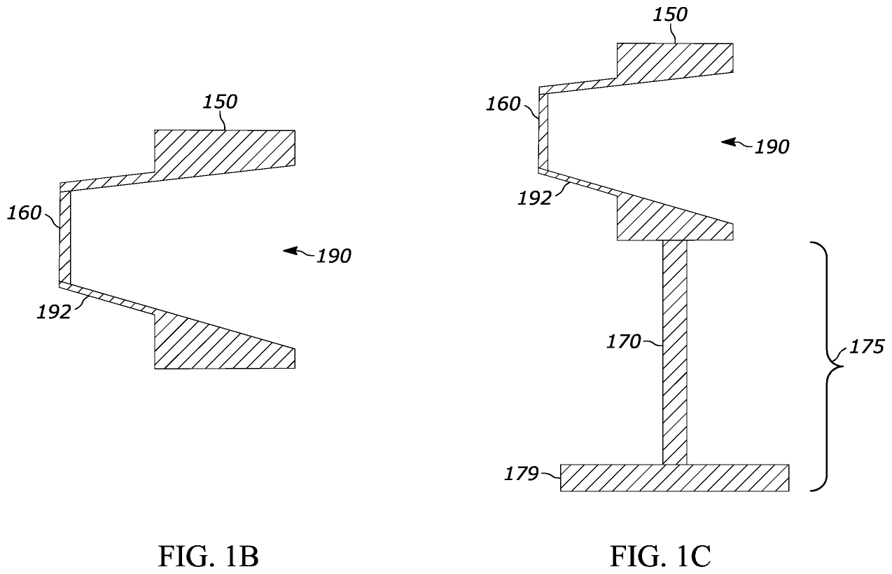

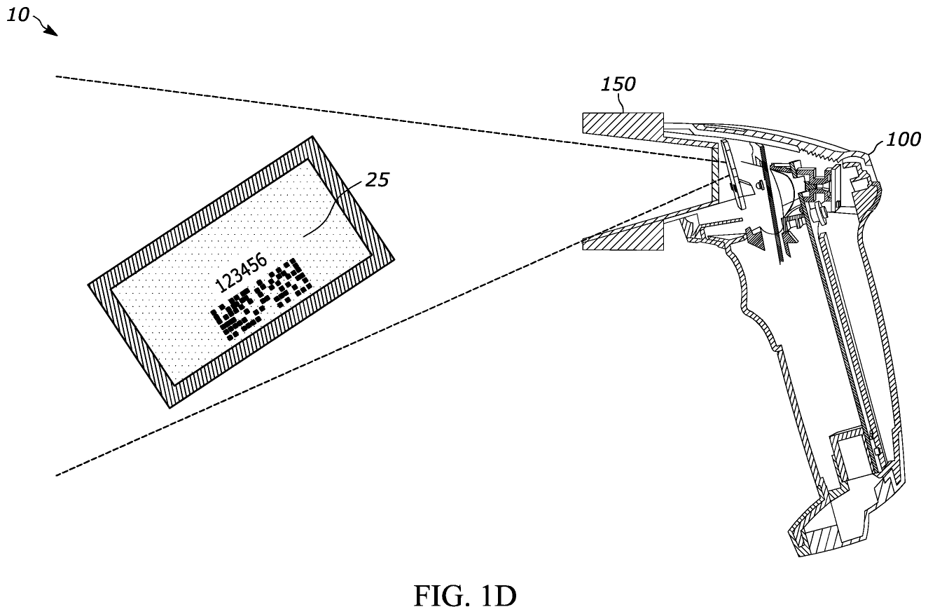

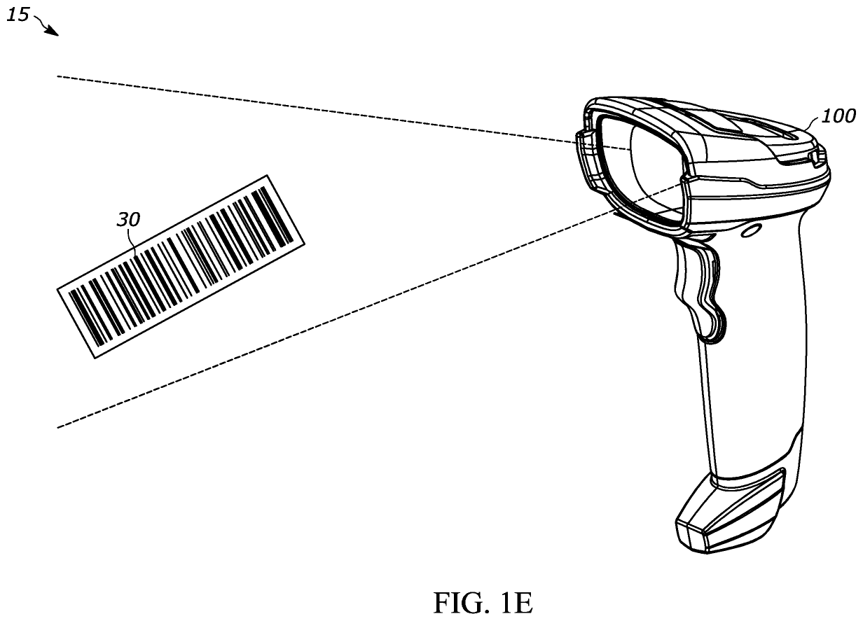

Referring to FIG. 1A, shown therein is an exemplary symbology reader 100 having a housing 42 with a cavity for housing internal components, a trigger 44, and a window 120. The symbology reader 100 can be used in a hands-free mode as a stationary workstation when it is placed on the countertop in a supporting cradle. The symbology reader 100 can also be used in a handheld mode when it is picked up off the countertop (or any other surface) and held in an operator's hand. In the hands-free mode, products can be slid, swiped past, or presented to the window 120. In the handheld mode, the barcode reader 120 can be aimed at a barcode on a product, and the trigger 44 can be manually depressed to initiate imaging of the barcode. In some implementations, the supporting cradle can be omitted, and the housing 42 can also be in other handheld or non-handheld shapes.

Referring to FIGS. 1B-1C, illustrated are exemplary attachments 150 to be coupled to the symbology reader 100 of FIG. 1A. In some embodiments, the symbology reader 100 has a direct illumination system configured to enable the symbology reader 100 to read barcodes. In these embodiments, coupling the attachment 150 to the symbology reader 100 redirects light produced by the direct illumination system of the symbology reader 100 such that diffuse light exits a cavity 190 of the attachment 150. Accordingly, when the symbology reader 100 is coupled to the attachment the symbology reader 100 is able to decode DPM codes within a field of view of the symbology reader 100. In additional or alternate embodiments, the symbology reader 100 has a diffuse illumination system. In these embodiments, the attachment 150 may be configured to enhance the light produced by the diffuse illumination system of the symbology reader 100 such that the light that exits the cavity 190 of the attachment 150 includes a wider or narrower range of angles. Consequently, the resulting image data generated an the imaging assembly of the symbology reader 100 exhibits higher contrast, improved focus, and/or better overall quality, thereby enabling the symbology reader 100 to decode highly reflective DPM codes and/or decode other DPM codes more quickly.

Turning to FIG. 1B in particular, illustrated is a side perspective view of an example hybrid illumination attachment 150. For example, the example attachment 150 of FIG. 1B may be configured for use with the symbology reader 100 when the symbology reader 100 is used in the handheld mode. The example attachment 150 includes a window 160. In some embodiments, the window 160 is configured to be adjacent to and/or rest upon a window of the symbology reader 100. The example attachment 150 also includes a housing 192 that defines the cavity 190. In some embodiments, an external surface of the housing 192 is contoured such that attachment 150 fits within a cavity (e.g., nose cavity) of a particular type of symbology reader 100 and/or a particular production line of symbology readers 100. Regardless of the particular contouring of the external surface of the housing 192, the internal surface of the housing 192 may be generally frustum-shaped and/or semi-frustum-shaped.

Turning to FIG. 1C in particular, illustrated is a side perspective view of an example hybrid illumination attachment 150 that includes a stand 175. For example, the example attachment 150 of FIG. 1C may be configured for use with the symbology reader 100 when the symbology reader 100 is used in the hands-free mode. Accordingly, the stand unit 175 may be the supporting cradle described with respect to FIG. 1A. As illustrated, the example stand unit 175 includes a base 179 and an arm 170. The arm 170 may be configured to permit a user to move or rotate the symbology reader 100 when the symbology reader 100 is coupled to the attachment 150 without moving the base 179. For example, in the embodiment illustrated in FIG. 1C, a central axis of the illumination light that exits the cavity 190 is substantially parallel to the base portion 179. In this example, the arm 170 may be configured to enable the user to rotate the symbology reader 100 such that the central axis of the illumination light that exits the cavity 190 is substantially orthogonal to the base portion 179. It should be appreciated that in some embodiments, the arm 170 may enable the user to rotate the symbology reader 100 in any direction. For example, the arm 170 may be coupled to the housing 192 via a ball and socket joint. As another example, the arm 170 may include a bendable length that enables the symbology reader 100 to be oriented at a plurality of different angles and/or orientations.

As shown in FIG. 1C, the attachment 150 may be coupled to the stand 175. In some embodiments, the housing 192 may be integrally formed with the stand 175. In other embodiments, the attachment 150 can be removably coupled to the stand 175. For example, the example attachment 150 of FIG. 1B may include a clip or fastener that couples the attachment 150 to the stand 175. In this example, the symbology reader 100 may be utilized in a hands-free mode when the attachment 150 is coupled to the stand 175 and in a handheld mode when the attachment 150 is uncoupled from the stand 175.

Referring now to FIG. 1D, illustrated is an example environment 10 where the symbology reader 100 is used to read a DPM code 25. As illustrated, the symbology reader 100 is coupled to the attachment 150 to produce a diffuse illumination light and/or increase the diffusivity of the illumination light to improve the ability of the symbology reader 100 to decode the DPM code 25. The DPM code 25 may encode information using a one-dimensional, two-dimensional pattern, and/or three-dimensional pattern. Accordingly, the DPM code 25 may be encoded using a pattern of topographical indications (e.g., varying the height of the object surface such as by removing or displacing material of the object, such as by use of a dot peen) or using a pattern of textural indications (e.g., using ablation techniques to cause some portions of the object to be rough and other portions of the object to be smooth). Generally, the DPM code 25 encodes information about an object on which the DPM code 25 resides, such as serial number, a part number, or another identifier of the object, a manufacturing date and/or location of the object, and/or a manufacturer of the object.

Due to the pattern of the DPM code 25 being encoded directly into the object, the DPM code 25 is preferably illuminated at an off-axis angle using diffuse light to be able to detect the pattern (or the shadows and/or reflections caused by the pattern). In some embodiments, the diffuse light impinging on the DPM code 25 may include off-axis angles between about 30° and 50°. In other embodiments, the diffuse light may include off-axis angles between about 20° and 60°. By providing off-axis, diffuse illumination, the specular reflection associated with surfaces subjected to direct illumination is mitigated, thereby improving the ability of the symbology reader 100 to detect the DPM code 25. In scenarios where the DPM code 25 is encoded using textural patterns, the reflective, non-rough sections of the DPM code 25 may be particularly susceptible to producing specular reflections that inhibit the ability of the symbology reader 100 to detect the DPM code 25. That said, the off-axis diffuse illumination may still improve the ability of the symbology reader 100 to decode the DPM code 25 when other DPM encoding techniques are used (or with barcodes printed on reflective surfaces).

Referring now to FIG. 1E, illustrated is an example environment 15 where the symbology reader 100 is used to read a barcode code 30. As illustrated, the symbology reader 100 is uncoupled from the attachment 150. The illustrated barcode 30 is not associated with specular reflections that inhibit the ability of the symbology reader 100 to decode the barcode 30. Accordingly, the symbology reader 100 may be configured to provide direct illumination when attempting to read the barcode 30.

It should be appreciated that in some embodiments, the symbology reader 100 is a dual mode reader capable of providing both an off-axis diffuse illumination light to read the DPM code 25 and direct illumination light to read the barcode 30. Accordingly, the symbology reader 100 includes a imaging assembly to detect reflected light when the symbology reader 100 is configured to provide the off-axis diffuse illumination light or the direct illumination light. In some embodiments, the imaging assembly includes two sets of image components respectively configured to detect reflected light when the off-axis diffuse illumination light is enabled and when the direct illumination light is enabled. In these embodiments, the attachment 150 may be configured to direct either the direct illumination light or the diffuse illumination light produced by the symbology reader 100 to a diffuser such that diffuse light or light with increased diffusivity exits the cavity 190 of the attachment 150.

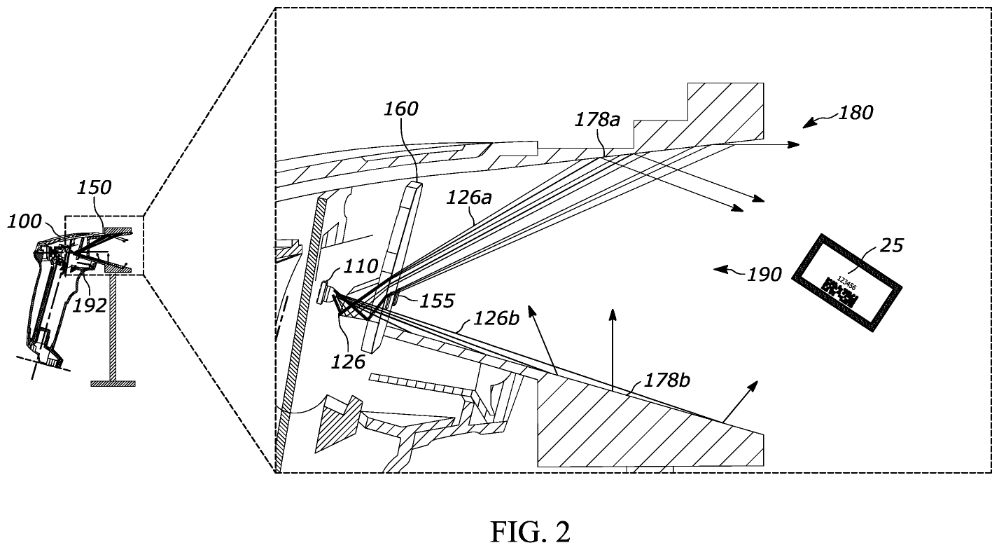

FIG. 2 is an exploded view of a housing 192 of the symbology reader 100 of FIGS. 1A-1E when coupled to the attachment 150 of FIGS. 1B-1E. FIG. 2 additionally illustrates an optical path 126 for light produced by an illumination assembly 110 of the symbology reader 100 as it passes through a window 160 of the attachment 150 and exits a cavity 190 towards a nose 180 of the attachment 150. By following the optical path 126, the illumination light produced by the illumination assembly 110 is diffuse when it exits the cavity 190 of the attachment 150.

As illustrated, the symbology reader 100 may include a window 120 separating the illumination assembly 110 and/or an imaging assembly (not depicted) from the rest of a cavity defined by a housing of the symbology reader 100. Accordingly, a window 160 of the attachment 150 may be positioned adjacent to the window 120 of the symbology reader 100. While FIG. 2 illustrates the windows 120 and 160 as being physical substrates, in other embodiments, one or more of the windows 120 and 160 are an open end of a cavity. In other words, a see-through substrate is not required to form the windows 120 or 160.

The cavity 190 of the example attachment 150 includes a diffuser 128 configured to diffusingly reflect light that impinges upon the diffuser 178 towards the DPM code 25. In the illustrated example, the diffuser 178 includes an upper diffuser 178a that lines an upper wall of the cavity 190 and a lower diffuser 178b that lines a lower wall of the cavity 190. It should be appreciated that while FIG. 2 depicts the diffuser 178 as being substantially horizontal, the diffuser 178 may be contoured to the frustum (or any other shape) of the interior surface of the housing 192. Further, while FIG. 2 depicts an embodiment where the diffuser 178 includes the upper diffuser 178a and the lower diffuser 178b may line a single wall of the cavity 190, multiple walls of the cavity 190, or all of the walls of the cavity 190.

To produce a diffuse reflection, the diffuser 178 generally has a textured surface that causes the illumination light that impinges thereupon to scatter at a plurality of different angles. For example, the diffuser 178 may include microstructures that, in aggregate, are generally smooth to human touch, but nonetheless provide a diverse range of reflection angles to diffusingly scatter the reflected light that impinged thereon. In some embodiments, to improve the reflectivity of the diffuser 178, the diffuser 178 is substantially white. As it is generally used herein, “white” may be defined in terms of the RGB color model where each of the red, green, and blue components are within a threshold value (e.g., 10%) of one another and wherein each of the red, green, and blue components have a value over 225. In some embodiments, the diffuser 178 is configured to reflect and/or scatter light substantially uniformly over multiple wavelengths, including light in the visible, ultraviolet, and/or infrared spectra. It should be understood such that in other embodiments the diffuser 178 can be any color or pigment that is particular adapted for reflecting light of particular wavelengths. For example, it may be preferable for the diffuser 178 to have a substantially red color in instances where the illumination assembly 110 emits red illumination light.

In the embodiment illustrated in FIG. 2, the diffuser 178 is a bezel or ring that lines the cavity 190. Accordingly, the diffuser 178 may be positioned proximate to the nose 180. For example, the diffuser 178 may be positioned at circumference of the housing 192 at least 75% of the length of the cavity 190 extending from window 160. In various embodiments, the diffuser 178 may line different portions of the cavity 190. For example, the diffuser 178 may line the entire length of the cavity 190, up to 75% of the length of the cavity 190, up to 50% of the length of the cavity 190, or even 10% or smaller.

As illustrated, the optical path 126 includes a plurality of component rays emitted by the illumination assembly 110 traversing respective paths through the cavity 190. It should be appreciated that for ease of explanation, not all rays of light emitted by the illumination assembly 110 are illustrated. The attachment 150 includes an optical element 155 disposed within the optical path 126 configured to direct the illumination light towards the diffuser 178. As illustrated, the optical element 155 may divide the optical path 126 into an upper optical path 126a directed at the upper diffuser 178a and a lower optical path 126b direct at the lower diffuser 178b. While FIG. 2 illustrates the upper optical path 126a being directed toward the upper diffuser 178a, in other embodiments, the upper optical path 126a may reflect off an upper wall of the cavity 190 while being directed to the lower diffuser 178b. Similarly, in these embodiments, the lower optical path 126b may reflect off a lower wall of the cavity 190 while being directed to the upper diffuser 178a.

It should be appreciated that while FIG. 2 illustrates the optical element 155 as being disposed on the window substrate 160, in other embodiments where the window 160 is an open end of the cavity 190, the optical element 155 may be affixed to a substrate extending across a length of the window 190 and/or a substrate extending from the housing 192 towards the optical path 126.

While FIG. 2 illustrates the optical element 155 being configured to direct the entirety of the illumination light produced by the illumination assembly 110 to impinge upon the diffuser 178, this may not be possible, or desirable, in all implementations. To this end, as long as at least half of the illumination light emitted by the illumination assembly 110 impinges upon the diffuser 178, there is a sufficient amount of off-axis illumination to be able to readily detect and/or decode a DPM code within the FOV of the symbology reader 100. Additionally, the illumination assembly 110 may produce a wide illumination field such that some of the illumination (in most cases not intentionally) is not directed at optical element 155. Accordingly, for this portion of the illumination field, the illumination light does not interact with the optical element 155 at an angle that enables the optical element 155 to direct the illumination light toward the diffuser 178. Similarly, the optical element 155 may not be an ideal optical element capable of directing all of the light emitted by the illumination assembly 110 toward the diffuser 178. Consequently, the optical element 155 may be configured to direct at least 50% of the illumination light to impinge upon the diffuser 178. Said another way, the ratio of light that ratio of the illumination light that enters the window 160 and impinges on the diffuser 178 and the illumination light that enters the window 160 and passes through the cavity 190 without impinging on the one or more walls is greater than or equal to 1:1.

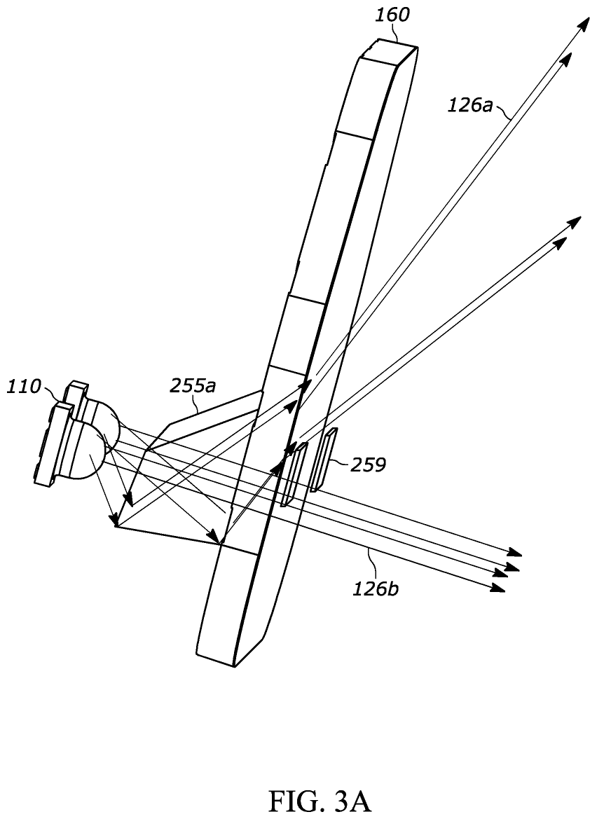

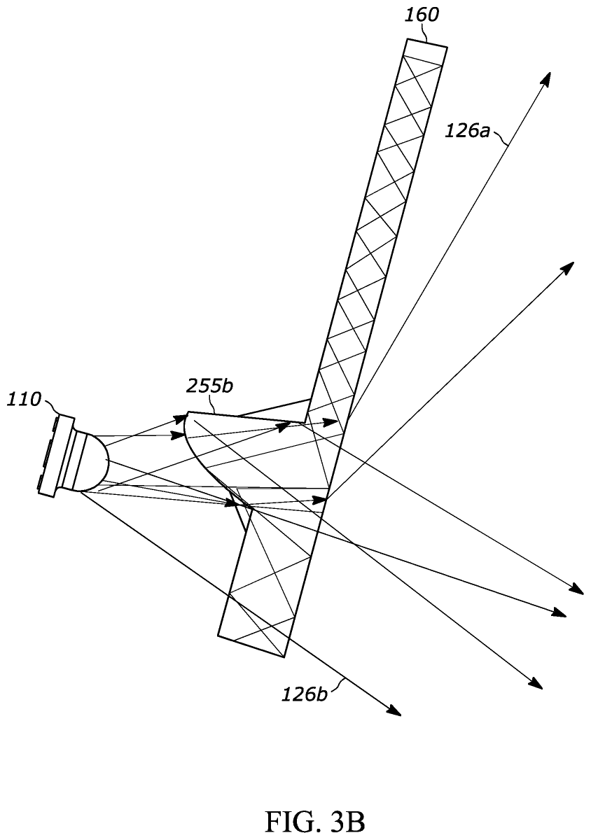

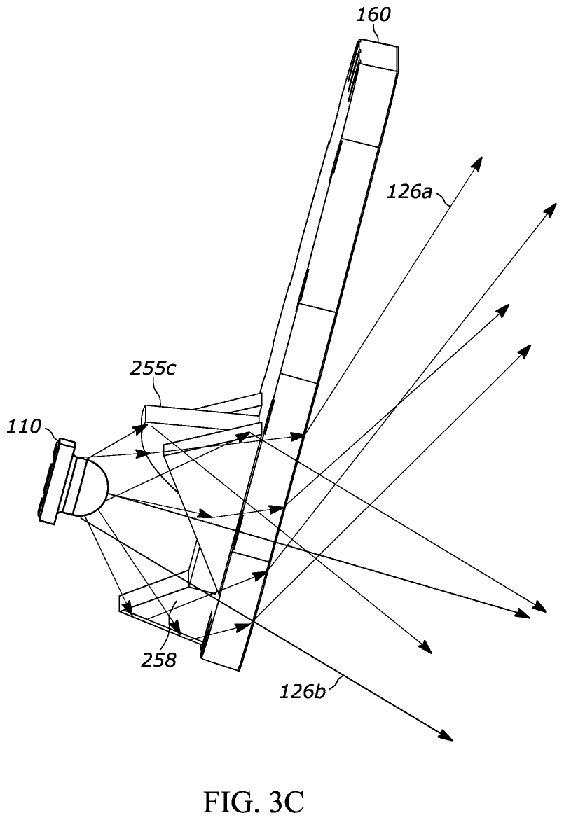

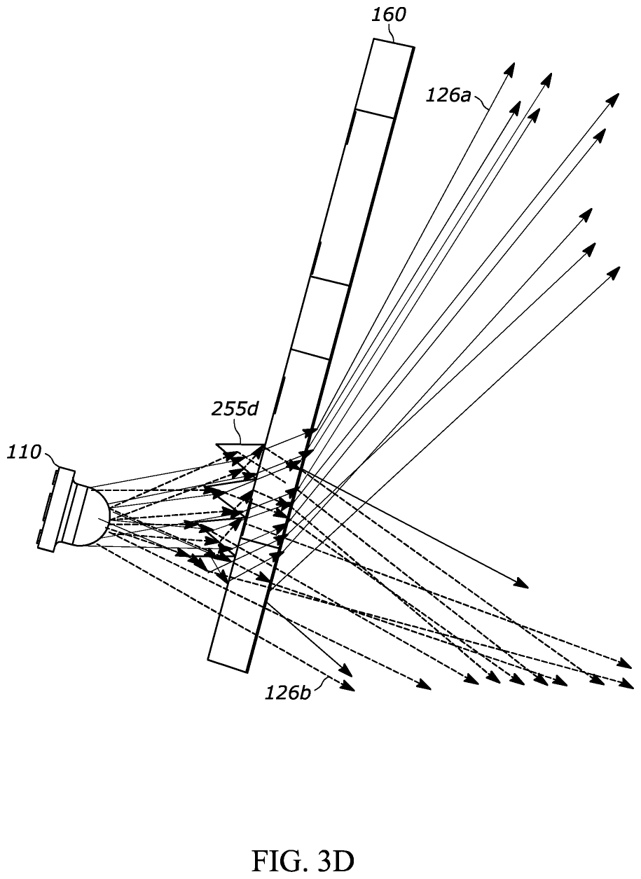

FIGS. 3A-3D are exploded views of a housing of the symbology reader 100 as coupled to the attachment 150 of FIGS. 1 and 2. More particularly, FIGS. 3A-3D illustrate the optical path 126 for light produced by the illumination assembly 110 being directed toward the diffuser 178 by different types of optical elements 255. The optical element 155 of the attachment 150 of FIGS. 1-2 may be any of the optical elements 255. It should be appreciated that while FIGS. 3A-3D illustrate the optical elements 255 as being disposed on the side of the window 160 closer to the illumination assembly 110, in other embodiments, the optical elements 255 may be disposed on the side of the window 160 closer to the nose 180 of the symbology reader 100.

Starting with FIG. 3A, illustrated is the optical path 126 for light produced by the illumination assembly 110 being directed toward the diffuser 178 by a polygon pipe 255a (such as a lens) and an obscurator 259. The obscurator 259 is configured to block the illumination light produced by the illumination assembly 110 from passing through the polygon pipe 255a and exiting the nose 180 without impinging upon the diffuser 178. The obscurator 259 may be any opaque substrate that blocks the illumination light, such as a plastic substrate, a piece of tape or a sticker, a scratch or other light blocking feature introduced onto the window 160, and so on. Accordingly, only the upper optical path 126a is directed toward the upper diffuser 178a and the lower optical path 126b is directed toward the lower diffuser 178b pass through the polygon pipe 255a and beyond the obscurator 259. It should be appreciated that in the embodiment of FIG. 3A, the optical element 155 may include both the polygon 255a and the obscurator 259.

Turning to FIG. 3B, illustrated is the optical path 126 for light produced by the illumination assembly 110 being directed toward the diffuser 178 by a lens 255b. As illustrated, the lens 255b is configured to direct light that would otherwise exit the nose 180 without impinging upon the diffuser 178 to impinge upon the diffuser 178. Accordingly, the lens 255b is configured to direct a first portion of the direct light along the optical path 126a toward the upper diffuser 178a and a second portion of the direct light along the optical path 126b toward the lower diffuser 178b.

Referring now to FIG. 3C, illustrated is the optical path 126 for light produced by the illumination assembly 110 being directed toward the diffuser 178 by a lens 255c having a lower reflector portion 258. In some embodiments, the lens 255c has substantially the same geometry as the lens 255b. As illustrated, the lower reflector portion 258 is configured to direct an additional portion of the illumination field produced by the illumination assembly 110 toward the diffuser 178. More particularly, the lower reflector portion 258 may be configured to direct the illumination light along the upper optical path 126a toward the upper diffuser 178a. It should be appreciated that in the embodiment of FIG. 3C, the optical element 155 may include both the lens 255c and the lower reflector portion 258.

Referring now to FIG. 3D, illustrated is the optical path 126 for light produced by the illumination assembly 110 being directed toward the diffuser 178 by a Fresnel lens 255d. As illustrated, the Fresnel lens 255d is configured to direct light that would otherwise exit the nose 180 without impinging upon the diffuser 178 to impinge upon the diffuser 178. Accordingly, the Fresnel lens 255d is configured to direct a first portion of the direct light along the optical path 126a toward the upper diffuser 128a and a second portion of the direct light along the optical path 126b toward the lower diffuser 128b. As illustrated, while the Fresnel lens 205d is occupies less space than the lens 205b or 205c, the Fresnel lens 205d also is more difficult to mold and permits more leakage light to pass through the first portion 125 without impinging upon the diffuser 128.

It should be appreciated that the optical elements illustrated in FIGS. 3A-3D are merely exemplary types of optical elements 155. Other embodiments may include other types of optical elements. For example, the obscurator 259 may be used in combination with any of the lens 255b-d or the polygon pipe 255a may include a lower reflector portion 258. Alternatively, to reduce the amount of space occupied the optical element 155, the optical element 155 may include just the obscurator 259 without any lens 255. As another example, the optical element 155 may include one or more mirrors configured to direct the illumination light toward the diffuser 178. As yet another example, the optical element 155 may include a substrate configured such that total internal reflection directs the illumination light toward the diffuser 178.

FIG. 4A is a perspective view of an attachment 350 (such as the attachment 150 of FIGS. 1-2), in accordance with an example embodiment. As illustrated, the attachment 350 includes a frustum-shaped housing 392 that includes a cavity through which illumination light produced by a symbology reader (such as the symbology reader 100 of FIGS. 1-2) passes. Additionally, the example attachment 350 includes a window 360 on which an optical element 355 is coupled. It should be appreciated that while the example optical element 355 is an obscurator (such as the obscurator 259 of FIG. 3A), the optical element 355 may be any optical element consistent with the teachings herein.

The example attachment 350 also includes a mount 394 adapted to receive the symbology reader 100. For example, the mount 394 may be shaped to generally conform to a shape of a housing for a particular model of symbology reader 100. As illustrated, the mount 394 may include a clip 396 configured to removably couple the symbology reader 100 to the attachment 350 such that symbology reader 100 and the attachment 350 are jointly portable. For example, the clip 396 may be a tab that is received into a recess of the symbology reader 100. As another example, the clip 360 may be a cavity adapted to receive the housing of the symbology reader 100 and/or a feature thereof. In the illustrated embodiment where the attachment 350 that includes a stand 375, the symbology reader 100 is operable in a hands-free mode when the symbology reader 100 is coupled to the attachment 350. In other embodiments where the attachment 350 does not include a stand, the symbology reader 100 may be operable in a handheld mode when the symbology reader 100 is coupled to the attachment 350.

While the foregoing embodiments improve the diffusivity of light produced by attachments such that symbology readers are better able to read DPM codes, additional improvements may be implemented to further improve the ability of the symbology readers to read DPM codes. To this end, while the foregoing techniques provide a diffuse illumination light when the attachment is coupled to the symbology reader, the diffuse light may not be evenly distributed. Said another way, the field of view of the imaging assembly of the symbology reader may include hotspots of diffuse illumination. If a DPM code is disposed at one of these hotspots within the FOV, the symbology reader may be less able to read the DPM code. Accordingly, the following improvements to the attachment produce a more evenly distributed diffuse illumination to reduce the formation of hotspots within the FOV of the imaging assembly.

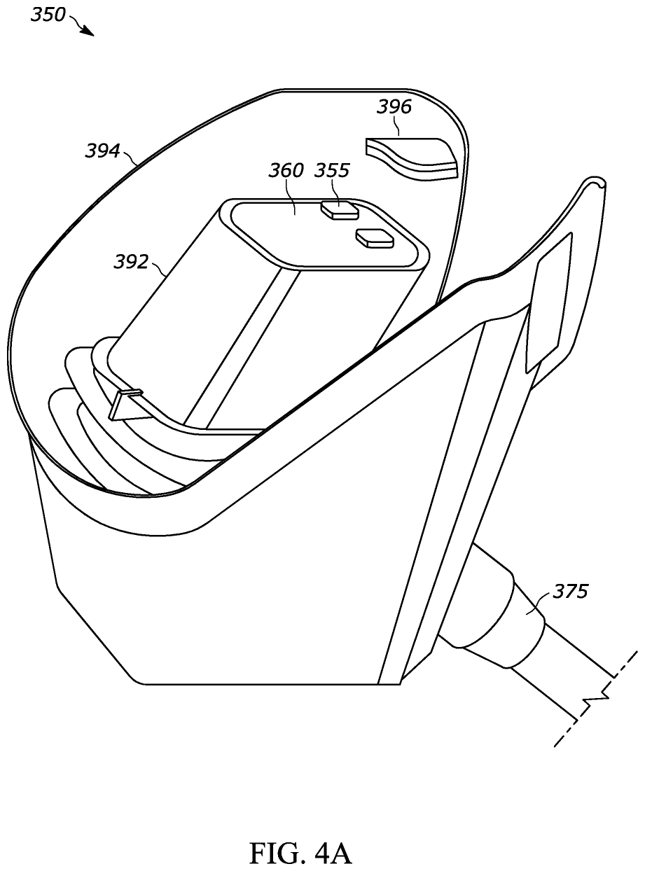

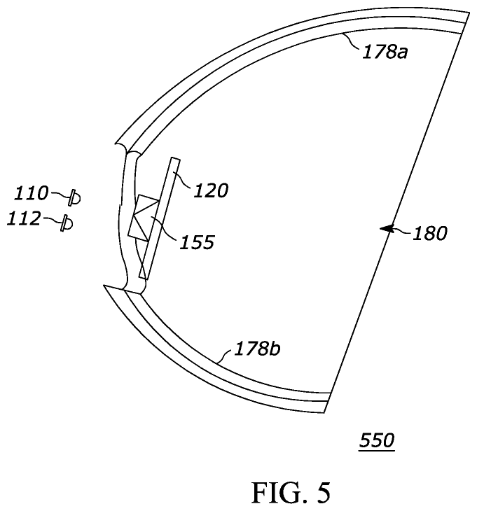

Referring now to FIG. 5, illustrated is example embodiment of an attachment 550, such as the attachments of FIGS. 1-4 where the housing cavity of the attachment 550 is shaped to improve the uniformity of the diffuse light emitted from a nose of the attachment 550. As illustrated, the cavity (and thus, the diffuser that lines the walls thereof) is shaped as an ellipsoid. Due to the ellipsoidal shape, the field of illumination produced by the diffuse illumination assembly 110 impinges upon the diffuser 178 at a wider variety of angles. Accordingly, the diffuser 178 diffusingly scatters the field of illumination more evenly across the FOV of the imaging assembly. It should be appreciated that in alternate embodiments, the housing cavity may be shaped as paraboloid (or any other concave spline swept 360° about an axis of rotation), a semi-ellipsoid, a semi-paraboloid, a pyramidal frustum, or a conical frustum. As shown in the embodiment illustrated in FIG. 5, other than the shape of the housing cavity and the optical element, the attachment 550 may include substantially the same features as the attachment 150 of FIG. 2.

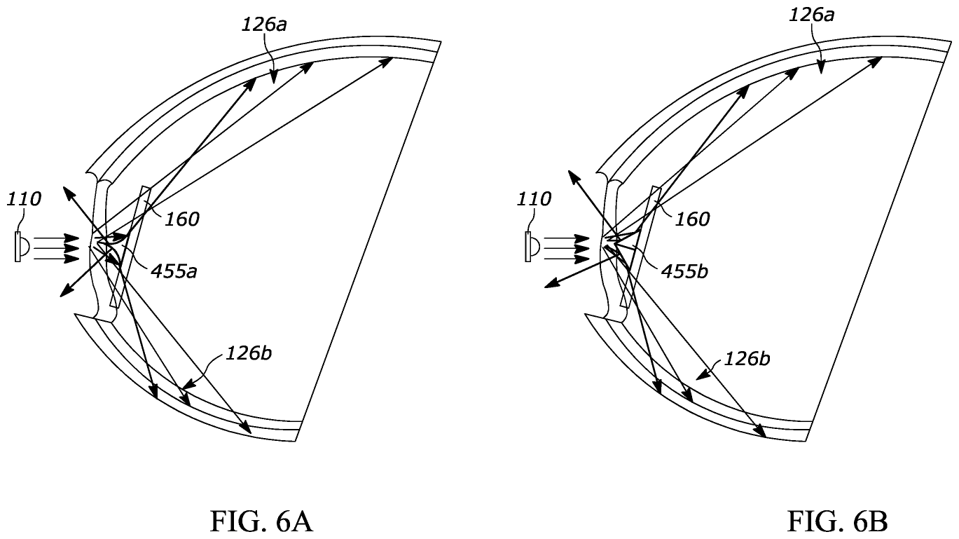

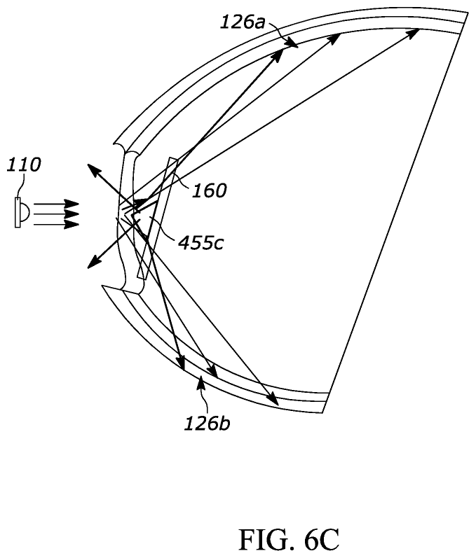

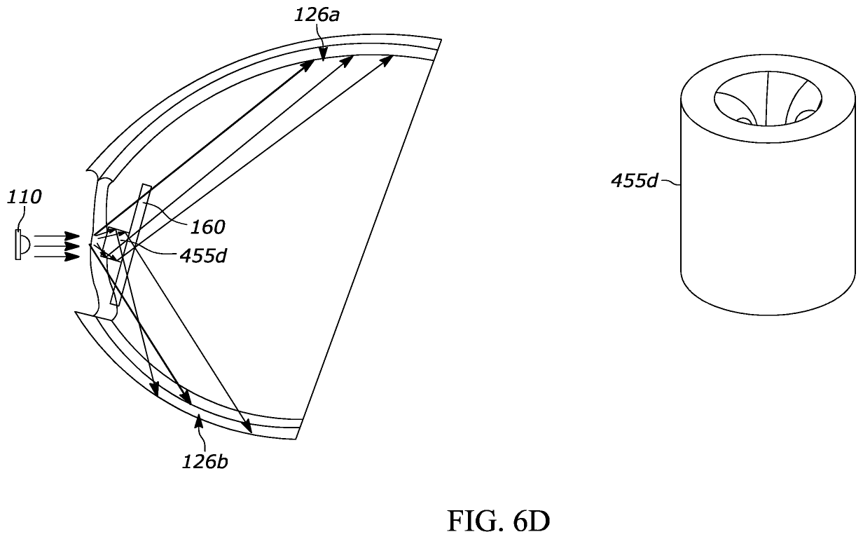

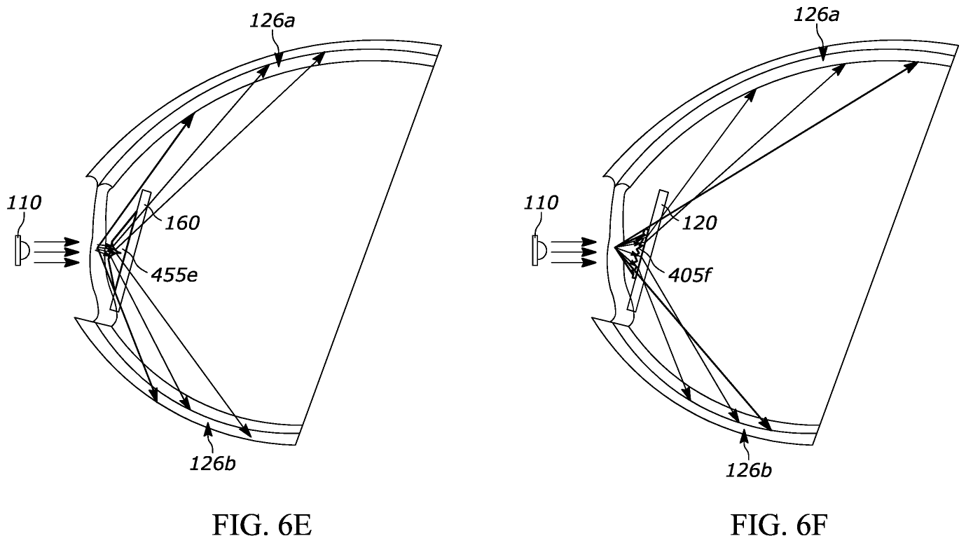

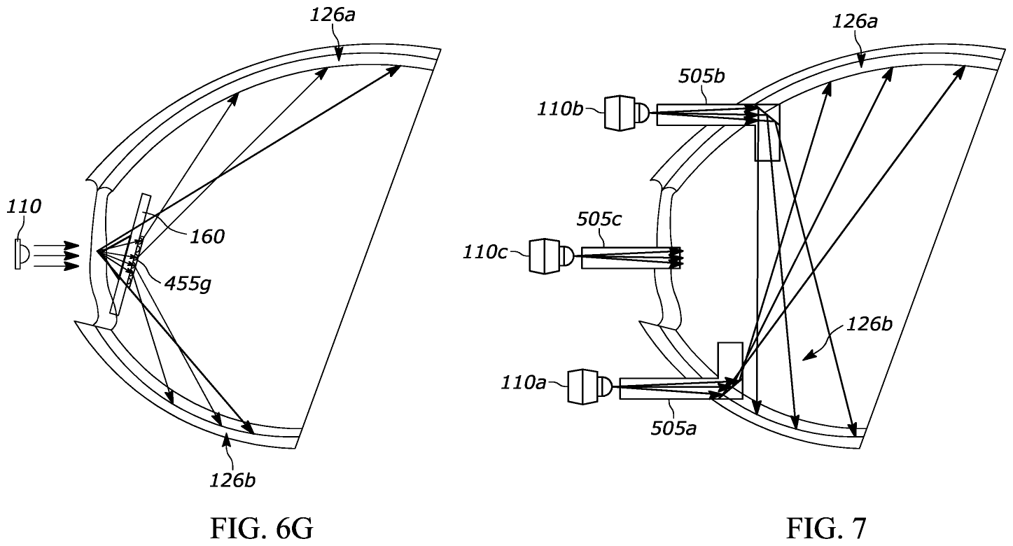

Turning to FIGS. 6A-6G, illustrated are example optical paths for light being directed to the diffuser 178 of the attachment 550 of FIG. 5 by optical elements 455. FIGS. 6A-6C illustrate the optical path for light being directed by reflector optical elements 455a-c and FIGS. 6D-6G illustrate the optical path for light being directed by refractor optical elements 455d-g.

Starting with FIG. 6A, illustrated is the optical path 126 for light produced by the illumination assembly 110 being directed toward the diffuser 178 by a reflective axicon 455a. In some embodiments, the surface of the reflective axicon 455a is a convex equivalent of the concave spline that defines the shape of the housing cavity. As illustrated, the pointed end of the reflective axicon 455a may be aligned with a central axis of the field of illumination of the illumination assembly 110 to evenly direct the light towards the diffuser 178 along the upper optical path 126a or the lower optical path 126b. It should be appreciated that not all of the light produced by the illumination assembly 110 is reflected by the reflective axicon 455a. To this end, the reflective axicon 455a may be dimensioned such that light that would pass through the housing cavity without impinging upon the diffuser 178 is reflected towards the diffuser 178 and that light that would impinge upon the diffuser 178 even without the presence of the reflective axicon 455a is permitted travel along its ordinary path toward the diffuser 178.

Turning to FIG. 6B, illustrated is the optical path 126 for light produced by the illumination assembly 110 being directed toward the diffuser 178 of the attachment 550 of FIG. 5 by a reflective pyramid 455b. In embodiments where the housing cavity is pyramidal, the surface of the reflective pyramid 455b generally matches the shape of the housing cavity. As illustrated, the pointed end of the reflective pyramid 455b may be aligned with a central axis of the field of illumination of the illumination assembly 110 to evenly direct the light towards the diffuser 178 along the upper optical path 126a or the lower optical path 126b. It should be appreciated that not all of the light produced by the illumination assembly 110 is reflected by the reflective pyramid 455b. To this end, the reflective pyramid 455b may be dimensioned such that light that would pass through the housing cavity without impinging upon the diffuser 178 is reflected towards the diffuser 178 and that light that would impinge upon the diffuser 178 even without the presence of the reflective pyramid 455b is permitted travel along its ordinary path toward the diffuser 178.

Turning to FIG. 6C, illustrated is the optical path 126 for light produced by the illumination assembly 110 being directed toward the diffuser 178 of the attachment 550 of FIG. 5 by a reflective cone 455c. In embodiments where the housing cavity is conical, the surface of the reflective cone 455c generally matches the shape of the housing cavity. As illustrated, the pointed end of the reflective cone 455c may be aligned with a central axis of the field of illumination of the illumination assembly 110 to evenly direct the light towards the diffuser 178 along the upper optical path 126a or the lower optical path 126b. It should be appreciated that not all of the light produced by the illumination assembly 110 is reflected by the reflective pyramid 455b. To this end, the reflective cone 455c may be dimensioned such that light that would pass through the housing cavity without impinging upon the diffuser 178 is reflected towards the diffuser 178 and that light that would impinge upon the diffuser 178 even without the presence of the reflective cone 405c is permitted travel along its ordinary path toward the diffuser 178.

Turning now to FIG. 6D, illustrated is the optical path 126 for light produced by the illumination assembly 110 being directed toward the diffuser 178 of the attachment 550 of FIG. 5 by a refractive revolved prism 455d. As illustrated by the perspective view of the revolved prism 455d, the revolved prism 455d may have a cylindrical exterior surface, but an interior surface shaped as an axicon. In some embodiments, the surface of the internal axicon 455a is a convex equivalent of the concave spline that defines the shape of the housing cavity. As illustrated, the center of the revolved prism 455d may be aligned with a central axis of the field of illumination of the illumination assembly 110 to evenly direct the light towards the diffuser 178 along the upper optical path 126a or the lower optical path 126b. It should be appreciated that not all of the light produced by the illumination assembly 110 is refracted by the revolved prism 455d. To this end, the revolved prism 455d may be dimensioned such that light that would pass through the housing cavity without impinging upon the diffuser 178 is refracted towards the diffuser 178 and that light that would impinge upon the diffuser 178 even without the presence of the revolved prism 455d is permitted travel along its ordinary path toward the diffuser 178.

Turning now to FIG. 6E, illustrated is the optical path 126 for light produced by the illumination assembly 110 being directed toward the diffuser 178 of the attachment 550 of FIG. 5 by a refractive axicon 455e. As illustrated, the pointed end of the refractive axicon 455e may be aligned with a central axis of the field of illumination of the illumination assembly 110 to evenly direct the light towards the diffuser 178 along the upper optical path 126a or the lower optical path 126b. It should be appreciated that not all of the light produced by the illumination assembly 110 is refracted by the refractive axicon 455e. To this end, the refractive axicon 455e may be dimensioned such that light that would pass through the housing cavity without impinging upon the diffuser 178 is refracted towards the diffuser 178 and that light that would impinge upon the diffuser 178 even without the presence of the refractive axicon 455e is permitted travel along its ordinary path toward the diffuser 178.

Turning now to FIG. 6F, illustrated is the optical path 126 for light produced by the illumination assembly 110 being directed toward the diffuser 178 of the attachment 550 of FIG. 5 by a refractive Fresnel lens 455f. The Fresnel lens may be substantially similar to the Fresnel lens 255d of FIG. 3D. It should be appreciated that not all of the light produced by the illumination assembly 110 is refracted by the Fresnel lens 455f. To this end, the Fresnel lens 455f may be dimensioned such that light that would pass through the housing cavity without impinging upon the diffuser 178 is refracted towards the diffuser 178 and that light that would impinge upon the diffuser 178 even without the presence of the Fresnel lens 455f is permitted travel along its ordinary path toward the diffuser 178.

Turning now to FIG. 6G, illustrated is the optical path 126 for light produced by the illumination assembly 110 being directed toward the diffuser 178 of the attachment 550 of FIG. 5 by a refractive microlens array 455g. Lenses of the microlens array may have slightly different indices of refraction causing the light emitted by the illumination assembly 110 to be refracted at a plurality of different angles. As illustrated the microlens array 455g is configured to have a gradient of indices of refractions centered about the central illumination axis of the illumination assembly 110 to evenly direct the light towards the diffuser 178 along the upper optical path 126a or the lower optical path 126b. It should be appreciated that not all of the light produced by the illumination assembly 110 is refracted by the microlens array 455g. To this end, the microlens array 455g may be dimensioned such that light that would pass through the housing cavity without impinging upon the diffuser 178 is refracted towards the diffuser 178 and that light that would impinge upon the diffuser 178 even without the presence of the microlens array 455g is permitted travel along its ordinary path toward the diffuser 178.

It should be appreciated that the optical elements illustrated in FIGS. 6A-6G are merely exemplary types of optical elements 155. Other embodiments may include other types of optical elements configured to direct the light produced by the diffuse illumination assembly 110 toward the diffuser 178.

For example, FIG. 7 illustrates the optical path 126 for light produced by the illumination assembly 110 being directed toward the diffuser 158 via light pipes 555. The light pipes 555 may be optic cabling that guides the light along a path using total internal reflection. While the example embodiment illustrated in FIG. 7 depicts the attachment 550 including three light pipes 555, alternate embodiments may include any number of light pipes.

As illustrated, a proximal end of the each light pipe 555 may by positioned to receive most of the light produced by the respective diffuse illumination assembly 110 and the distal end of each light pipe 555 is disposed within the housing cavity. It should be appreciated that the distal ends of the light pipes 555 may be evenly distributed along a plane of the housing cavity. As a result, the composite of the light passing through the light pipes 555 is more evenly distributed about the FOV for the imaging assembly of the symbology reader. In alternate embodiments, rather than aligning the proximal ends of the light pipes 555 with a illumination assembly of the symbology reader, the external surface of the housing 192 includes optical guides that direct light emitted by the illumination assembly 110 into the proximal end of the light pipes 505.

In some embodiments, a lens is positioned over the distal end of each light pipe 555. The lens may be configured to spread the light exiting the light pipe 555 over a broader range of angles. Consequently, including a lens over the distal end of each light pipe 555 further improves the uniformity of light across the FOV for the imaging assembly. Accordingly, in some embodiments, the optical element 155 is just the light pipe 555, and in other embodiments, the optical element 155 is the light pipe 555 and its corresponding lens.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An attachment for a symbology reader comprising:
a mount configured to couple the symbology reader to the attachment;
a housing that defines a cavity defined by one or more walls;
a diffuser positioned within the cavity and configured to diffusingly reflect light that impinges thereon;
a first optical element configured to direct a first amount of a total amount of illumination light produced by the symbology reader to impinge on the diffuser.

2. The attachment of claim 1, wherein the first optical element includes a lens.

3. The attachment of claim 2, wherein the lens is a Fresnel lens.

4. The attachment of claim 2, wherein the lens includes a lower reflector portion configured to redirect the illumination light towards a portion of the diffuser located on an upper surface of the cavity.

5. The attachment of claim 1, wherein the first optical element includes an obscurator that prevents most of the illumination light from passing through the cavity without impinging on the one or more walls.

6. The attachment of claim 1, wherein the housing is frustum-shaped and the diffuser lines the one or more walls of the cavity.

7. The symbology reader of claim 6, wherein the diffuser is at least a section of the one or more walls that is substantially white.

8. The attachment of claim 1, wherein the illumination light is a first illumination light, and the attachment further comprises:
a second optical element configured to direct at least 70% of a second illumination light produced by the symbology reader to pass through the cavity without impinging on the one or more walls.

9. The attachment of claim 8, wherein the first optical element and the second optical element are integrally formed on a substrate.

10. The attachment of claim 1, further comprising:
a window positioned within the cavity and configured to permit illumination light emitted by the symbology reader to pass therethrough.

11. The attachment of claim 1, wherein the mount comprises:
a stand comprising:
a base configured to support the attachment; and
an arm configured to permit a user to move or rotate the symbology reader when the symbology reader is coupled to the mount without moving the base of the stand.

12. The attachment of claim 1, wherein the mount comprises:
a clip configured to removably couple the symbology reader to the attachment such that the symbology reader is operable in a handheld mode when the symbology reader is coupled to the attachment.

13. The attachment of claim 1, wherein the window is configured to be adjacent to a window of the symbology reader when the symbology reader is coupled to the attachment.

14. The attachment of claim 1, wherein the cavity of the housing forms at least one of an ellipsoid, a paraboloid, a semi-ellipsoid, a semi-paraboloid, a conical frustum, or a pyramidal frustum.

15. The attachment of claim 14, wherein the first optical element is a reflector.

16. The attachment of claim 15, wherein the reflector forms the shape of one of an axicon, a pyramid, or a cone.

17. The attachment of claim 14, wherein the first optical element is a refractor.

18. The attachment of claim 17, wherein the refractor is one of a revolved prism, a Fresnel lens, or a microlens array, or forms the shape of an axicon.

19. The attachment of claim 14 wherein the first optical element includes at least one optical pipe.

20. An attachment for a symbology reader comprising:
a holder configured to couple the symbology reader to the attachment;
a housing that defines a cavity being further defined by one or more walls;
a diffuser positioned within the first portion of the cavity, the diffuser configured to diffusingly reflect light that impinges thereon;
a lens assembly configured to direct illumination light that passes from the symbology reader toward the attachment to impinge upon the diffuser.

21. The attachment of claim 20, wherein the diffuser lines the cavity.

22. The attachment of claim 20, wherein the lens assembly includes a Fresnel lens.

23. The attachment of claim 20, wherein the lens assembly comprises at least one of (i) a lower reflector portion configured to redirect a portion of the illumination light being emitted downward with respect to an imaging FOV of the symbology reader to be directed upwards with respect to the imaging FOV or (ii) an upper reflector portion configured to redirect a portion of the illumination light being emitted upward with respect to an imaging FOV of the symbology reader to be directed downwards with respect to the imaging FOV.

24. The attachment of claim 20, wherein the lens assembly includes an obscuration tab configured to prevent most of the illumination light from passing through the cavity without impinging on the diffuser.

25. The attachment of claim 20, further comprising:
a window positioned within the cavity and configured to permit an illumination light generated by the symbology reader to pass therethrough.

26. The attachment of claim 20, wherein the holder comprises:
a stand comprising:
a base configured to support the attachment; and
an arm configured to permit a user to move or rotate the symbology reader when the symbology reader is coupled to the mount without moving the base of the stand.

27. The attachment of claim 20, wherein the holder comprises:
a clip configured to removably couple the symbology reader to the attachment such that the symbology reader is portable in a handheld mode when the symbology reader is coupled to the attachment.
